(19) United States
(12) Patent Application Publication
(10) Pub. No.: US 2008/0107890 A1
(43) Pub. Date: May 8, 2008

(54) Tie Layer and Method for Forming Thermoplastics

(75) Inventors: Martin N. Bureau, Montreal (CA); Jean-Gabriel Legoux, Repentigny (CA); Sylvain Belanger, Longueuil (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: NATIONAL RESEARCH COUNCIL OF CANADA, Ottawa, ON (CA)

(21) Appl. No.: 11/813,804

(22) PCT Filed: Jan. 13, 2006
(86) PCT No.: PCT/CA06/00039

§ 371 Date: Jul. 12, 2007

Related U.S. Application Data
(60) Provisional application No. 60/643,599, filed on Jan. 14, 2005.
(60) Provisional application No. 60/676,299, filed on May 2, 2005.

(51) Int. Cl. B29C 70/86; B05B 1/24; B29C 41/20; B29C 41/22; C08J 7/06; B32B 7/12; B29C 43/18; B29C 70/78

(52) U.S. Cl. 428/323; 264/176.1; 264/328.1; 427/427; 427/446; 428/332; 428/412; 428/457; 428/473.5; 428/474.4; 428/500; 428/704

(57) ABSTRACT

A tie layer for bonding a ceramic or metallic coating to a thermoplastic substrate is described. The tie layer comprises from 2 to 70% ceramic and/or metallic filler particles in a thermoplastic matrix. The thermoplastic matrix is compatible with the thermoplastic substrate. Further, a method of bonding a ceramic or metallic coating to a thermoplastic substrate is disclosed. The method involves applying the tie layer to the substrate, and bonding the ceramic or metallic coating to the tie layer using a coating process that consolidates the substrate, the tie layer and the coating. The tie layer and process are useful in coating implantable prosthetic bones, or coating industrial items used in automotive, aeronautical or medical industries.

### CROSS REFERENCE TO RELATED APPLICATIONS

This application claims the benefit of priority of U.S. Provisional Patent Application No. 60/643,599 filed Jan. 14, 2005, and of U.S. Provisional Patent Application No. 60/676,299 filed May 2, 2005, each of which is incorporated herein by reference.

### FIELD OF THE INVENTION

The present invention relates generally to thermal spraying, and particularly relates to a tie layer formulation and a method for bonding a coating to a thermoplastic-based substrate.

### BACKGROUND OF THE INVENTION

The formation and adhesion of thermal spray coatings over heat sensitive materials is a technical challenge. Historically numerous techniques have been used to overcome this problem. However, no solution has been found for thermal spraying thermoplastic-based substrates, such as unfilled thermoplastics polymers, particle- or fiber-filled thermoplastic polymers, fiber reinforced composites with a thermoplastic matrix, that is applicable to a large variety of materials.

The use of thermoplastic composites in automotive, transport, aeronautical, industrial, and medical applications is in rapid expansion. In order to improve their performance and take advantage of their unique properties, it is becoming more and more important to modify the surface properties of thermoplastic-based materials to respond to the peculiar conditions that real service conditions are imposing to parts made from these materials, including wear & abrasion, thermal shock or extreme temperature exposition, indentation & fretting, sliding, chemical, biochemical and biologic environments, etc. Coatings need to be design to improve the performance of these thermoplastic-base materials, i.e., by improving their resistance to wear & abrasion, thermal shock or extreme temperature exposition, indentation & fretting, sliding, chemical, biochemical and biologic environments, and providing their biocompatibility, bioinertness, bioactivity, osteoconductivity, osteoinductivity, hemocompatibility, etc.

In order to produce coatings over heat sensitive parts, such as thermoset-based materials, including glass or carbon fiber/epoxy composites, numerous techniques have been used. Depending on the application and the nature of the coating, different types of thermal sprayed chemically bonded coats have been used [1]. Other techniques for bonding coatings have also been described, some involve as forming of a topography at the surface conducive to bonding (e.g. roughing the surface), or binding the layer to exposed fibers, which act as anchor points [2], adding a particle-charged thermoset resin at the surface of parts [3], or using high power heat removal devices [4]. These techniques have been mostly used on thermoset-based materials. Some research has been directed toward the production using thermal spraying of ceramic particle/thermoplastic compounds [5-8]. Research is also directed to potential use of chemical bond coats made of low melting point materials (Huber, EP00052186A1) or blends of polymer and metals [9,10]. Electrochemical solution has also been suggested to be used if the bond material is Cu or Ni [1]. However, none of these techniques are independent of the sprayed materials which might be prohibited for certain applications.

Disadvantageously, the use of adhesives which form chemical bonds between a substrate and a coating may cause undesirable results for the thermoplastic substrate, and thus an alternative to an adhesive is desirable.

### SUMMARY OF THE INVENTION

It is an object of the present invention to obviate or mitigate at least one disadvantage of previous thermoplastics or previous methods for forming thermoplastics.

According to an aspect of the invention, there is provided a tie layer for bonding a ceramic or metallic coating to a thermoplastic substrate, comprising from 2 to 70% filler particles in a thermoplastic matrix, the thermoplastic matrix being compatible with the thermoplastic substrate, and the filler particles being ceramic, metallic, or a combination or composite thereof.

A further aspect of the invention provides a method of bonding a ceramic or metallic coating to a thermoplastic substrate comprising: applying a tie layer to the substrate, the tie layer comprising a thermoplastic matrix compatible with the thermoplastic substrate, and from 2 to 70% filler particles embedded in the matrix, the filler particles being ceramic, metallic, or a combination or composite thereof; and bonding the ceramic or metallic coating to the tie layer using a coating process that consolidates the substrate, the tie layer and the coating.

Another aspect of the invention provides a method of bonding a ceramic or metallic coating to an implantable prosthetic bone comprising applying a tie layer, as described herein, to a prosthetic bone and subsequently bonding the ceramic or metallic coating to the tie layer using thermal spray material deposition.

Advantageously, the filler particles act to shield the substrate from the coating process. For example when the coating process comprises a thermal spray, the capacity of the filler particles to withstand and absorb applied heat prevents damage of the substrate surface, while allowing the compatible thermoplastic matrix to bond to the thermoplastic substrate. In this way, the applied heat required in a thermal spray process does not damage the substrate.

As a further advantage, filler particles found within the tie layer act to bind mechanically through mechanical interlocking or chemically through chemical affinity of the ceramic or metallic material of the coating and the filler particles of the tie layer with the applied ceramic or metallic layer that is applied thereon in the coating process. In the embodiment where the surface of the tie layer has exposed filler particles at the surface, or is modified to have such particles exposed, the coating process allows the ceramic or metallic coating to bond with exposed filler, while the thermoplastic component of the tie layer consolidates with the substrate below.

As a further advantage, for such coating processes that do not require application of heat, the consolidation of the tie layer with the substrate still allows shielding of the substrate. For example, if chemical application of the coating would have deleterious effects on the substrate, the tie may perform the function of a protective barrier.

Advantageously, the use of a tie layer in bonding ceramic or metallic coatings to a thermoplastic substrate allows for superior bonding, and prevents problems relating to quality control for coatings on substrates subjected to rigorous use. The tie layer may prevent or reduce chipping or wear of a ceramic or metallic coating, and may allow application of coatings which were previously believed to be to difficult to accomplish.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 illustrates typical microstructures of tie layer film composites according to the invention.

FIG. 2 shows the typical microstructure of HA coating plasma sprayed on the tie layer film overmolded on the composite substrate.

FIG. 3. illustrates adhesion strength of HA plasma sprayed coated structure with different tie layer compositions.

FIG. 4. shows a shear stress fatigue curve for composite and tie layer assembly with different tie layer compositions.

FIG. 5 shows an embodiment of the application of the tie layer for the adhesion of a plasma spray coating on a cylindrical part. Left side: a schematized view of the part. Right side: a photo of the actual part (approx 1.9 cm diameter).

FIG. 6 Osteoblast surface after 7 days (a) HA on PA12C (b) nano-TiO₂ on PA12C.

FIG. 7 is a pictorial representation of an exemplary hydroxyapatite (HA) coating on the CF/PA12 (carbon fiber/polyamide 12) composite with a tie layer (or “film interlayer”) according to an embodiment of the invention.

### DETAILED DESCRIPTION

Generally, the present invention provides a tie layer for bonding a ceramic or metallic coating to a thermoplastic substrate. The tie layer comprises from 2 to 70% of metallic or ceramic filler particles in a thermoplastic matrix. The thermoplastic matrix is compatible with the thermoplastic substrate.

The thermoplastic matrix. The thermoplastic matrix may be formed of any polymer that is compatible with the substrate to be coated. By “compatible”, it is meant able to melt, meld, or otherwise bond together in a permanent manner. A number of known thermoplastics may be used with the invention, some of which are provided in the following list: PA, polyamide; PET, polyethylene terephthalate; PBT, polybutylene terephthalate; PSU, polysulfone; PES, polyethersulfone; PAS, polyarylsulfone; PPS, polyphenylene sulfide; PC, polycarbonate; PA, polyamide; PAI, polyamide-imide; TPI, thermoplastic polyimide; PAEK, polyaryletherketone; PEEK, polyetheretherketone; PAEN, polyarylethernitrile; PE, polyethylene; PP, polypropylene; PEK, polyetherketone, or a combination of these. Of course, other thermoplastics may be used with the invention. An exemplary thermoplastic matrix for use with the tie layer is polyamide 12 (PA12). The thermoplastic matrix may be one that is miscible with the polymeric composition of the substrate. Co-polymers, composites, such as nano-composites may be used.

The filler particles. The filler particles embedded within the tie layer are particles of metallic or ceramic materials, or combinations or composites of such materials, with or without a specific aspect ratio. Hydroxyapatite, stainless steel, WC—Co, zirconia (ZrO₂), alumina (Al₂O₃), silica (SiO₂) or titania (TiO₂) may also be used. Other such materials not listed here may also be employed, depending on the desired application. Exemplary filler particles may be formed of hydroxyapatite, Ti, titanium oxide, a CaP ceramic, or composites or combinations of these.

The filler particles are present at a level adequate to provide shielding to the substrate below, and generally fall within the approximate range of from 2 to 70% of the tie layer (by volume). In a preferred embodiment, the tie layer may comprise from 10 to 40% filler particles.

The particles may be of any acceptable size or shape adequate to effect such shielding. For example, particles may be spherical, irregular, filamentous, or fibrous. In general, the particles can range in average diameter from 1 nm to 100 μm. particles in the size range of nano particles, for example having a diameter of from 1 nm to 100 nm, may be used. Further particles ranging in diameter from 100 nm to 100 μm, in the micro particle range, may be used. Nano and micro particles may be used either alone or in combination with each other.

Properties of the tie layer. The tie layer may have a thickness of from 0.05 to 1 mm., for example 200-300 μm. Filler particles may be exposed on the surface of the tie layer, so as to permit direct contact between the ceramic or metallic coating and the embedded particles in the tie layer. The exposed particles may be either incidentally present after formation of the tie layer, or may be emphasized using a tie layer surface modification (such as sand blasting, etching, scratching, or polishing), as described further with reference to the method of forming the tie layer.

The tie layer may be pre-formed in the form of a film, or may be formed directly on the substrate surface, as described in more detail below.

Method for forming the tie layer. The invention further relates to a method of bonding a ceramic or metallic coating to a thermoplastic substrate. In a broad aspect, the method comprises applying a tie layer to the substrate followed by bonding the coating to the tie layer so as to consolidate the substrate, tie layer and coating. The tie layer comprises a thermoplastic matrix compatible with the thermoplastic substrate, and contains from 2 to 70% filler particles embedded in the matrix. The filler particles being formed of ceramic, metallic, or of a combination or composite of both ceramic and metallic, have a higher heat capacity than the thermoplastic substrate. This allows the filler particles to absorb and withstand the applied heat, protecting the substrate below. Bonding of the ceramic or metallic coating to the tie layer is conducted using a coating process that consolidates the substrate, the tie layer and the coating.

The coating process may comprises any procedure that allows the substrate, tie layer and coating to bond together. A general example of this is thermal spray material deposition. Other specific coating processes which may be used include, for example, plasma spraying, arc-spraying, high velocity oxy-fuel spraying (HVOF), cold spraying, vacuum plasma spraying (VPS), kinetic metallization, or cold gas dynamic application.

According to an embodiment of the invention, the tie layer may be formed as a film prior to application to the substrate. In this case, the film may be formed in any way acceptable in the art, for example by extruding a film stretched from melt, or by blowing a film from melt form using air.

According to another embodiment of the invention, the tie layer can be applied to the substrate as a dry powdered mixture. The dry powdered mixture could then be melted and will form a uniform surface through application of heat from thermal spray material deposition, radiation or convection heating. In other applications of the invention, it may be desirable to have non-uniform application of the dry powdered mixture, so that the regions without a tie layer act as a mask to prevent later bonding of the coating, if desired. In the instance where a dry powder is used, the mixture melts and forms a tie layer under the ceramic or metallic coating upon application of the coating through thermal spray material deposition.

According to embodiments of the invention, the tie layer may be applied to the substrate using any acceptable method, for example by spraying, compression molding, injection overmolding, or co-injection molding.

The method may additionally comprise the step of preparing the tie layer surface so as to expose particles on the surface of the tie layer. Examples of such surface preparations (or modifications) include sand blasting, sanding, etching, polishing or scratching.

According to a specific embodiment of the invention, there is provided a method of bonding a ceramic or metallic coating to an implantable prosthetic bone comprising applying a tie layer as disclosed herein to a prosthetic bone and subsequently bonding the ceramic or metallic coating to the tie layer using thermal spray material deposition. Formation of a particular implantable prosthetic bone is disclosed in applicants' co-pending PCT patent application entitled “Implantable biomimetic prosthetic bone” filed on Jan. 13, 2006, the entirety of which is herein incorporated by reference. Briefly, bone tissue at the interface of a bone implant is shielded from stresses found in normal bone because of the higher stiffness or rigidity in the implant versus in bone. The resulting “stress shielding” of the bone by the implant eventually results in resorption of bone at the bone-implant interface and ultimately necessitates replacement of the bone implant. To overcome these problems, an implantable biomimetic prosthetic bone having a rough or porous surface, a fiber-reinforced composite structure, and a polymer-based core is disclosed. The prosthetic bone is a good match for structure, stiffness, viscoelastic properties, specific weight and overall structure as real bone or host tissues adjacent to the prosthetic bone. The prosthetic bone may be formed as a total hip prosthesis. The surface of the prosthetic bone may comprise hydroxyapatite applied to the underlying fiber-reinforced composite. In a particular exemplary embodiment, a tie layer containing hydroxyapatite and PA12 is used to bind a surface layer of hydroxyapatite to a CF/PA12 composite substrate.

According to the invention thermal spray hydroxyapatite (HA) coatings can be successfully applied on a thermoplastic polymer composite substrate. In an exemplary embodiment CF/PA12 is used (68 wt. % long carbon fibers, CF; and 32 wt. % polyamide 12, PA12).

Attempts aimed at coating CF/PA12 composite directly by means of plasma spraying illustrated that proper adhesion of coatings was difficult to achieve, mostly because of the thermal degradation of the composite leading to a destruction of the composite. Other attempts made to create different surface profiles by embossing or machining techniques did not arrive at the success observed with certain embodiments of the invention. It was noted that the presence of fibers at the surface was enhancing the adhesion of the coating, as already described in the literature [2]. Attempts were also made to introduce a layer of particles embedded at composite surface by heating the surface above the polymer matrix melting temperature and pressing the composite over a particle bed. This method was found to improve the adhesion, but did not provide adequate control of the thickness of the particle-rich surface layer. Best adhesion was obtained when particles appeared well embedded in the polymer matrix.

By inserting a tie layer, composed of a thermoplastic matrix that is thermoplastically compatible or miscible within a thermoplastic-based substrate, and a filler in the form of metallic or ceramic particles (with or without a specific aspect ratio), on the surface of the substrate prior to thermal spraying, high quality coatings can be produced on thermoplastic-based materials. These coatings show good mechanical adhesion and very low thermal damage of the heat sensitive thermoplastic-based material substrate.

As used herein, the term ‘substrate’ designates any object, piece, part or material to be coated using the tie layer according to the invention.

One embodiment of the invention employs a tie layer, produced on a surface of a heat sensitive substrate prior to thermal spray coating, to successfully bind to the tie layer a coat of a ceramic, a metal, or a blend thereof.

Another embodiment of the invention provides a method that allows formation of the tie layer directly at the surface of the substrate during thermal spraying, by placing a dry blend of the constituents of the tie layer described above in the form of particles or powder, which melts and produces a uniform surface tie layer under the action of heat during thermal spraying of the desired coating. Heat may be applied by thermal spraying, or by any other means of radiation or convection heating.

Overmolding, laminating, primary molding or dry powder formation heating are 4 ways of producing the tie layer. Heating of the thermal spray is absorbed by the particles or powder causing them to melt into a particle-filled or powder-filled thermoplastic compound and further mitigating damage to the substrate cause by the heat of the thermal spray.

Another embodiment of the invention allows production of a tie layer, having the composition described herein, by any other means available from polymer chemistry to produce such tie layer. For example, dissolution of a thermoplastic matrix followed blending of filler and solvent extraction to produce the film of tie layer or the raw compound that can be transformed into such a film of tie layer. Other techniques of solidifying a tie layer with the composition described herein can be used in other embodiments.

The invention involves introducing a thermoplastic-based compound in the form of a surface tie layer over a thermoplastic-based substrate. Suitable compositions for the tie layer are described herein which allow bonding or a ceramic and/or metallic layer to a heat sensitive substrate thermoplastic.

The tie layer preferably contains from 2 to 70% (v/v) of particles (i.e. filler) compounded into a thermoplastic matrix. The filler may include ceramic particles (including nitrides, carbides, borides, oxides, and glasses), metals (including alloys), and composites and particle blends thereof. All of these filler particles are applied in similar thermal spray operations (temperatures etc.), and bond in substantially the same manner using mechanical anchoring.

The tie layer may have a thickness ranging from 0.05 to 1 mm.

It has been found that the improvements in coating adhesion results from both the mechanical interlocking of splats in the coating caused by impact of the thermal spray material, and the filler in the surface tie layer of the substrate, and the thermoplastic bond produced between the polymer matrix of the tie layer and the polymer matrix of the substrate. Therefore, any thermal spray coating can be produced using such a tie layer provided that the top surface of the tie layer is prepared to expose the particles enabling mechanical interlocking with the deposition material, and the tie layer can properly dissipate the heat produced by thermal spraying.

Advantageously, the tie layer provides an adequately high filler particle concentration and employs of particles formed of ceramic and/or metallic, thus having sufficient heat capacity, to dissipate the heat of the thermal spray process. The filler, or particle, component is substantially responsible for protection the underlying surface to be coated from detrimental heat effects. The thermal spray material thus is not restricted to the material or material type or family constituting the tie layer filler. The tie layer can be produced with any type of filler material provided that it adequately dissipate heat, provide good mechanical interlocking with the thermal spray material and can be formed into a surface compound as described herein. The tie layer can also be produced with any type of thermoplastic polymer, provided that it thermoplastically adheres well to the matrix of the thermoplastic-based substrate, i.e. that it is thermoplastically miscible or at least thermoplastically compatible with the matrix of the thermoplastic-based substrate, and also that it can be produced and formed into a surface layer as described herein.

The tie layer can be obtained by any means that can ensure mixing of the filler into polymeric matrix. A twin screw extruder (TSE) may be used. Internal mixers such as a Brabender™, single screw extruders with previous dry blending of the filler with thermoplastic powder or pellets may also be used. The compound can then be pelletized at the exit of the extruder (twin or single screw), or granulated into a more or less fine powder when produced by internal mixers. The latter granulated, powdered or pelletized compound can then be used to form a film using, preferably but not exclusively, cast film line extruders, film blowers, sheet extruders with or without calendaring, injection molding of thin plates (0.5 mm to 1 mm), or other applicable techniques. The tie layer film can then be overmolded on the thermoplastic-based material by compression molding, although it will be appreciated that other methods of fixing the film to the substrate such as calendaring or roll forming of film apposed to the substrate, and co-laminating the film over the substrate. The film could also but not exclusively be formed directly at the surface of the substrate by injection overmolding or co-injection molding, injection molding followed by compression molding, calendaring or roll forming of film apposed to the substrate, sheet forming followed by roll forming, etc. While these methods can be used to fix the film on an independently produced thermoplastic-based part, it will be appreciated that similar techniques can be used to apply the film directly on a part ready to receive thermal spraying during primary molding of the part.

Other techniques may be employed to produce and fix the tie layer on a thermoplastic-based substrate. For example, according to known powder coating techniques typically applied to metal substrates, a dry powder compound can be applied on the surface of a part and then melted to form the tie layer. Another way of doing the same would be to use a process similar to a known spray and fuse process to melt the surface compound and thus form the tie layer directly on the part. In the latter case the heat source might come directly from the thermal spray process or from any radiant or convective source, such as air blower, oven, lamps and electrical heating elements.

### EXAMPLES

### Example 1

### Hydroxyapatite (HA) Coating of PA12/CF Composite

The polymer composite substrate on which HA was to be applied was a composite of 68 wt. % long CF and 32 wt. % PA12.

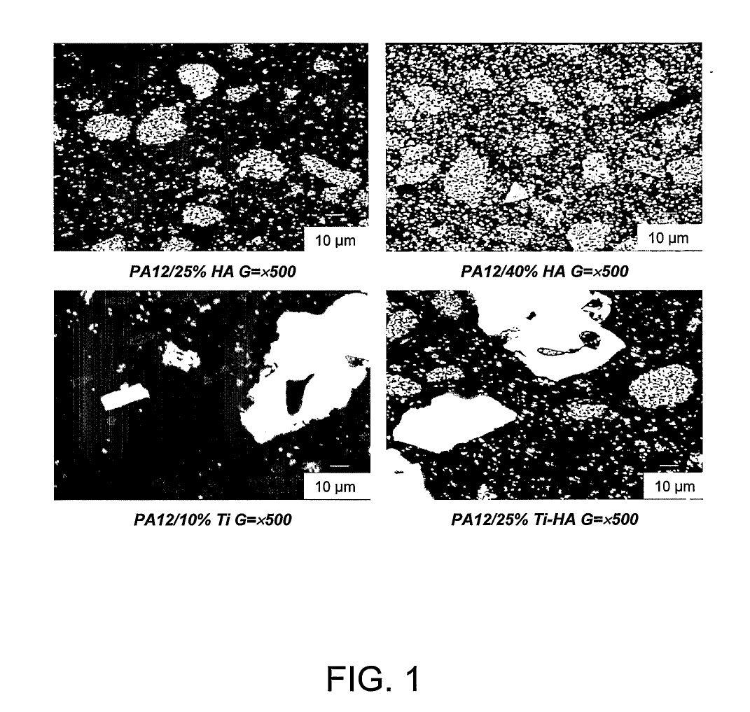

These results demonstrate that the incorporation (at the surface of the CF/PA12 composite) of a surface tie layer containing a predetermined amount of well dispersed particles within a PA12 matrix results in improved bond strength of thermal spray coatings. This surface tie layer was obtained by first compounding the particles in a PA12 matrix using a twin screw extruder (TSE) and pelletizing the PA12/particles compound. A 200-300 μm-thick film was produced from the pellets of this compound using a cast film line extruder. Different compositions were produced and tested, including 25 and 40% (v/v) HA/PA12 compounds, 10% (v/v) Ti/PA12 compound and 25% (v/v) (Ti+HA)/PA12 compound where Ti and HA were mixed at equal volume amounts. Microstructures of these different tie layer compositions are shown in FIG. 1.

The tie layer films were then overmolded on the CF/PA12 composite flat substrates by compression molding, although it will be appreciated that other methods of fixing the film to the substrate (such as injection molding, compression molding, calendaring (roll forming), sheet forming/roll forming, etc.) could alternatively be performed. Resulting thickness of the surface layer was generally found to be lower than the original film thickness, as a result of the co-infiltration of the polymer within the film and the coating.

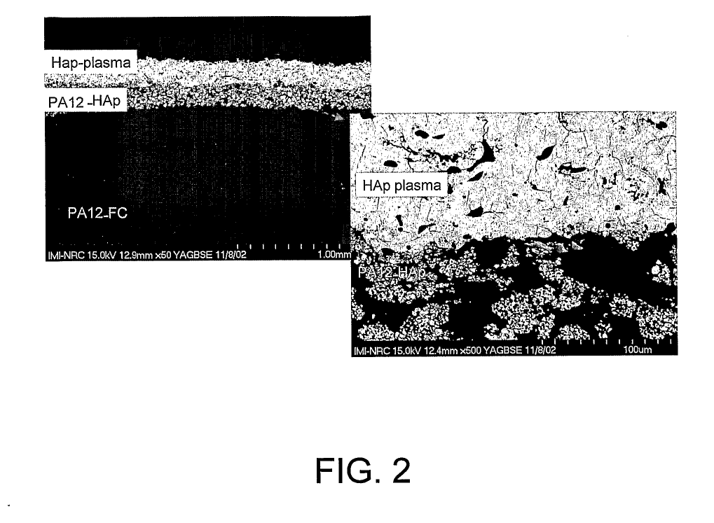

After a light sand blasting of the surface of the part to expose the particles of the tie layer, the thermal coatings were produced using spray conditions that impose a relatively low heat load on the substrates during spraying. A SG-100 plasma gun (Praxair) using argon at a flow rate of 60 L/min was used. The applied current of 500 A had a voltage of 31V. Since the substrate geometry was flat, the plasma gun was moved in an x-y plane parallel to the surface of the substrate. The gun was applied a gun transverse speed of 61 cm/s, and the surface was coated in overlapping passes. Each pass followed a parallel line and separated by a step size of 3.2-mm. The spray distance was set at 7.6 cm from the substrate to the torch. An example of the plasma sprayed coatings of HA is shown in FIG. 2.

Mechanical adhesion of HA coating was evaluated from pull tests, as recommended by ASTM F1609 Standard Specification for Calcium Phosphate Coatings for Implantable Materials. HA coated composite specimens used for pull tests were fixed to steel rods by means of a polyamide-epoxy adhesive (with a verified composite-steel adhesion of 30 MPa). An Instron™ mechanical tester with crosshead speed of 1.26 mm/min was used to evaluate the bond strength. The adhesion and/or cohesion strength was obtained from the maximum load divided by the nominal surface of the samples. A minimum of three pull tests were performed for each reported condition. Careful analyses of the fracture surface, at low magnification, were carried out in order to evaluate the type of generated failure.

The mechanical properties of the composite-film structure has been evaluated in fatigue under shear stresses by means of double lap shear specimen, as recommended in ASTM D3165 Standard Test Method for Strength Properties of Adhesives in Shear by Tension Loading of Single-Lap-Joint Laminated Assemblies.

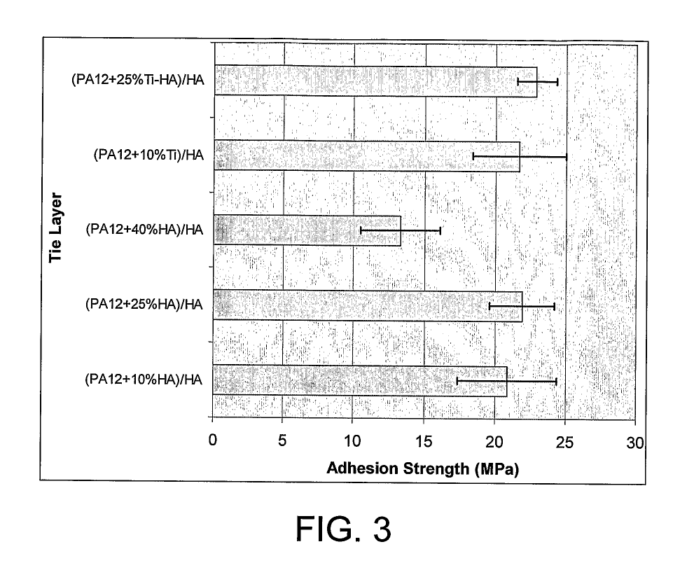

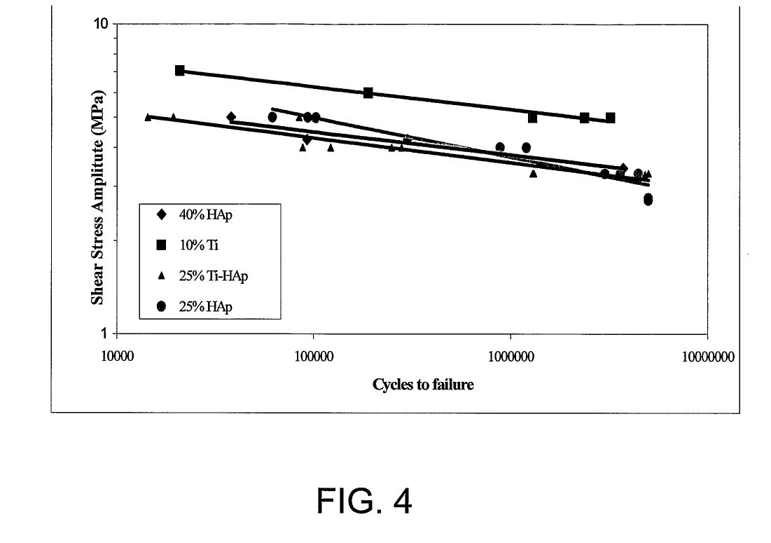

Results show that the use of the described surface tie layer, with different compositions as shown in FIG. 1, with a plasma sprayed HA coating over the above described composite makes it possible to obtain excellent adhesion and shear performance as demonstrated in FIG. 3 and FIG. 4, which comply with ISO 13779-2 (International Organization of Standardization. Implants for surgery—Hydroxyapatite—Part 2: Coatings of hydroxyapatite. ISO 13779-2. 2000). Such performance cannot be obtained by direct plasma spraying of hydroxyapatite coating over the above described thermoplastic material-based composite. It has been observed that direct plasma spraying destroys the thermoplastic substrate resulting in no adhesion.

### Example 2

### Coating on Complex Shape

The fabrication technique described in Example 1 has been used with success with a plasma sprayed coating of a CF/PA12 cylindrical part.

A 1.9 cm-diameter hollow cylinder composed of CF/PA12 composite stem, covered by a surface layer containing a predetermined amount of well dispersed particles within a PA12 matrix was manufactured. This surface layer was obtained by first compounding the particles in a PA12 matrix using a twin screw extruder (TSE) and pelletizing the PA12/HA particles compounding, followed by producing a 200-300 μm-thick film from the pellets of this compound using a cast film line extruder. A composition of 25% (v/v) HA/PA12 for the compound was used.

The film was then overmolded on the CF/PA12 composite cylindrical structures by inflatable bladder molding in a closed mold placed into a heated press. Resulting part was then coated with HA using plasma spray.

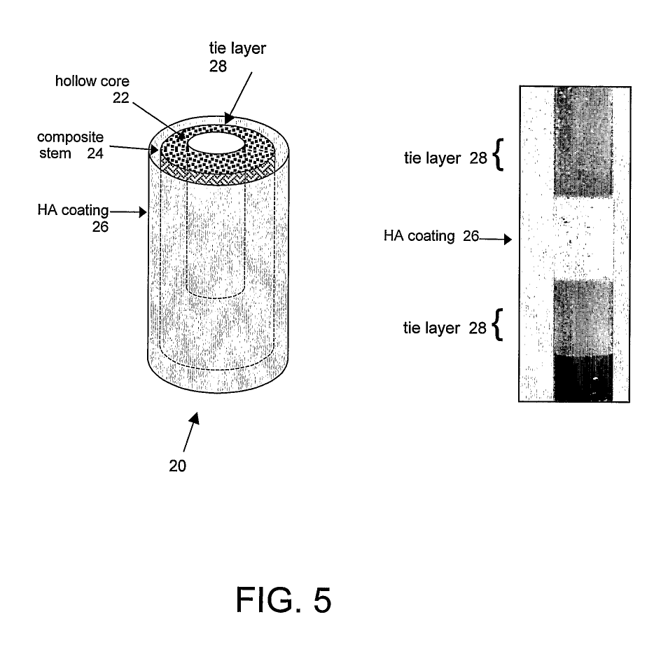

After lightly sand blasting the surface of the part in order to expose the particles of the tie layer, the coating was produced using an SG-100 plasma gun (Praxair) using argon at a flow rate of 60 L/min. The applied current was 500 A for a voltage of 31V. Since the sample geometry was cylindrical an axial rotational at a speed of 925 rpm was imposed to the part and a 4.9 cm/s transverse speed was applied to the plasma gun. The spray distance was set at 7.6 cm. The schematized view of a part so coated, and a photograph of a cylindrical part coated in certain regions are shown in FIG. 5.

FIG. 5 illustrates a tie layer for bonding a plasma spray hydroxyapatite (HA) coating on a cylindrical substrate, in this case a stem used for a prosthetic bone implant. On the left is shown a schematic view of the part (20) having a hollow centre (22), a composite stem (24), and an HA coating (26). Between the stem (24) and the HA coating (26) is found a tie layer (28) formed of 25% (v/v) HA/PA12. On the right is shown a photo of a cored section of the part formed. The hydroxyapatite coating (26) was deposited only in the central region of the stem, shown here as the lightest band. In this example, the hollow composite was covered on about % of its length by the tie layer (depicted as the upper ¾ dark gray region of FIG. 5.

### Example 3

### Coating Prosthetic Bone: Development of Osteoblast Colonies on Bioactive Coating

The aging baby boomer population coupled with an increase in life expectancy is leading to a rising number of active elderly persons in occidental countries. As a result, the orthopedic implant industry is facing numerous challenges such as the need to extend implant life, reduce the incidence of revision surgery and improve implant performance. This example reports results of an investigation on the bioperformance of coating-substrate systems. Hydroxyapatite (HA) and nano-titania (nano-TiO₂) coatings were produced on Ti-6Al-4V and fiber reinforced polymer composite substrates using a tie layer according to an embodiment of the invention. In vitro studies were conducted in order to determine the capacity of bioactive coatings developed to sustain osteoblast cells (fetal rat calvaria) adherence, growth and differentiation.

As revealed by SEM observations and alkaline phosphatase activity (ALP), cell adhesion and proliferation demonstrated that HA coatings over a polymer composite are at least as good as HA coatings made over Ti-6Al-4V substrate in terms of osteoblast cell activity. Nano-TiO₂ coatings produced by high-velocity oxy fuel (HVOF) spraying led to different results. For short term cell culture (4.5 and 24 hrs), the osteoblasts appeared more flattened when grown on nano-TiO₂ than on HA. The surface cell coverage after 7 days of incubation was also more complete on nano-TiO₂ than HA. These results indicate that osteoblast activity after 15 days of incubation on nano-TiO₂ is equivalent to or greater than that observed on HA.

Substrate Materials. Coatings were produced on two types of substrates, a titanium alloy (Ti-6Al-4V) that is widely used for hip prostheses and a polyamide 12/carbon fiber (PA12/CF) composite used for a novel design of hip prostheses as described in applicants' co-pending PCT patent application entitled “Implantable biomimetic prosthetic bone” filed on Jan. 13, 2006, the entirety of which is herein incorporated by reference. In order to improve the coating adhesion and heat resistance, a 100 μm layer made of twin-screw-extruder compounded PA12/HA was over-molded onto composite substrates was used as the tie layer, as described in detail above in Example 2.

Bioactive Coatings. Two types of coatings over two different substrates were produced: a plasma sprayed HA coating and a high-velocity oxy fuel (HVOF) nano-TiO₂ coating on both polymer composite and Ti-based substrates.

The HA coating involved a bioactive HA powder (Captal 30, Plasma Biotal Ltd, Tideswell, UK) was used for depositing HA coatings. Granulometry testing on the initial HA powder (LS Particle Size Analyzer, Beckham Coulter, Fullerton, Calif., USA) indicated a number-average diameter of 33 μm. The HA coatings were produced using atmospheric plasma spray.

The nano-TiO₂ coating involved titania feedstock employed in this work (VHP-DCS, Altair Nanomaterials Inc., Reno, Nev., USA) exhibited a nominal particle size range from 5 to 20 mm. Each feedstock particle was formed via the agglomeration of individual nanostructured TiO₂ particles smaller than 100 nm. The feedstock powder was thermally sprayed via the HVOF technique using an oxy-propylene based torch (Diamond Jet 2700-hybrid, Sulzer Metco, Westbury, N.Y., USA). The coatings were sprayed on grit-blasted substrates to roughen the surface prior to spraying. During the spraying process on the substrates a cooling system (air jets) was applied to reduce the coating temperature, which was monitored using a pyrometer. The maximum surface temperature was approximately 240° C. for the Ti-6Al-4V substrates and 130° C. for the PA12/CF substrates.

Osteoblast Isolation and Seeding. Osteoblasts were isolated from the calvariae of 21-day-old Spargue Dawley rat fetuses by sequential collagenase digestion as described by Bellows et al. (Calcif Tissue Int, Vol 38, 1986, 143-1542). The cells were then plated in T-75 flasks in a Dulbecco's modified Eagle medium (DMEM) containing 10% of fetal bovine serum (FBS). After 24 h the adhered cells were washed with phosphate buffer saline (PBS) to remove dead cells and other debris, then detached using 0.01% trypsin in PBS. The re-suspended cells were counted and seeded on the different disc-shaped material surfaces previously placed in the 6-well culture plates at 2×10⁻⁴ cells/well in an osteogenic medium (growth medium containing 50 mg/ml of ascorbic acid, 10 mM Na-b-glycerophosphate, and 1% antibiotics). The cells were incubated at 37° C. in a humidified atmosphere consisting of 95% O₂ and 5% CO₂ and allowed to grow for 4.5 h, 1, 7 and 15 days. For these periods, the medium was changed three times per week.

Osteoblast Adherence, Growth and Differentiation on Materials. Scanning electron microscopy (SEM) observation was used to determine the adherence, morphology and growth of the osteoblasts on the different coatings after 4.5 h, 1, 7 and 15 days. At the end of each incubation period, the cells were rinsed in phosphate buffer pH 7.2, fixed in a 0.089 M phosphate buffer solution containing 2.5% glutaraldehyde and 2.5 mM magnesium chloride, pH 7.2 for 3 hours. The samples were then rinsed in 0.1 M phosphate buffer, postfixed in 1% osmium tetroxide for 1 h, washed in distilled water three times and then dehydrated in a graded series of ethanol solutions (70% through 100% dry ethanol). Specimens were then treated with mixtures consisting of 75:25, 50:50, 25:75 and 0:100 ethanol:amyl acetate. The samples were dried by the critical-point drying method, sputter-coated by gold/palladium and observed using a scanning electron microscope (Hitachi, Model S-4700, manufacturer, Hitachi Science Systems, Ibarahi, Japan).

Alkaline Phosphatase (ALP) Activity The osteoblast phenotype of cells cultured on different surfaces was determined by enzymatic ALP activity test after 15 days. Before staining, coated samples (with attached cells) were rinsed once with cold PBS, then the cells were fixed in 10% cold neutral buffered formalin for 15 minutes, rinsed with distilled water, and then left in distilled water for 15 minutes. A fresh mixture constituted of 10 mg Naphthol AS MX-PO4 in 400 μl N,N-dimethylformamide, 50 ml distilled water, 50 ml of 0.2 M Tris-HCl pH 8.3, 60 mg red violet LB salt was used for ALP staining. The ALP staining mixture was placed on the coated samples covered with the fixed cells and incubated for 1 h at room temperature. All the chemicals were purchased from Sigma-Aldrich Chemical Company (Oakville, Canada). The different material discs were then removed from the wells, rinsed in tap water, drained and air-dried, and then photographed. The ALP positive signal was quantified with Imagine J software. For normalization, the background color was subtracted by setting a threshold.

Results: Coating Surfaces Characterization by SEM. Prior to cell culture experiments, HA and nano-TiO₂ coatings are quite different. Both coating surfaces are constituted of smooth zones formed from the solidification of a liquid and rougher areas constituted either of unmelted or ‘oversprayed’ material. The HA coating is considerably rougher than the nano-TiO₂ as can be expected when comparing a HVOF coating made with fast and small particles with plasma sprayed coatings made from relatively large and slow particles.

Cell Adhesion and Growth. After 4.5 h of incubation the coating surfaces were examined by SEM. It was noted that the two coating topologies are quite different, the plasma sprayed HA coating being rougher than the HVOF nano-TiO₂ that exhibits a smoother aspect caused by flattening of semi-molten particles impinging on the surface at high velocity. Osteoblasts found on the nano-TiO₂ are well flattened on the surface and have started to spread, whereas osteoblast cells do not appear to follow the contour of the HA coating surface. Also osteoblast cells were more difficult to locate on the HA surface, which might be related to a slower initial adhesion but also to the difficulty of locating cells on a rougher surface (e.g., cells at bottom of valleys). It was also noted that the HA coating surface was modified during its immersion in the culture media.

Images of cells after 1 day of incubation were assessed. For 4.5 h, cell morphology on HA and nano-TiO₂ coatings was quite different. Cells remained with an elongated shape on the HA coating, they had a close to circular shape on nano-TiO₂. Interestingly, osteoblast cells attached to the HA surface appeared partly covered by mineral concretion, probably some HA precipitated from the culture media.

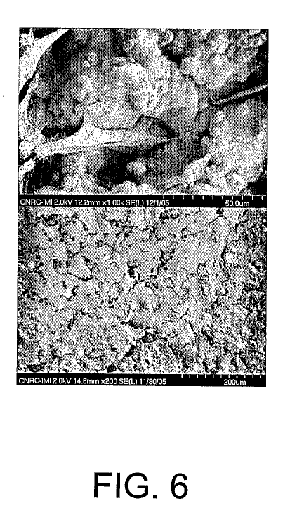

FIG. 6 illustrates that after 7 days, cells spread to the complete substrate surfaces. But while they remain elongated and penetrate the HA coating structure (a), they are covering the entire surface on TiO₂ coatings (b). Also apparent from part (a) is the smoother HA surface after 7 days of incubation in culture media when compared to the shorter time periods (data not shown). After 15 days, osteoblast cells are also covering the entire surface of HA coatings.

Alkaline Phosphatase (ALP) Activity and Cell Differentiation. After 15 days of incubation the number of cells was characterized by the staining of the alkaline phosphatase, which produce a red color. All surfaces were almost completely covered by red stained cells. Osteoblast morphology remains more elongated on the HA coatings compared with that developed on nano-TiO₂ coatings. It is difficult to evaluate the difference between white HA coatings and dark gray nano-TiO₂ coatings mainly because of the difference in contrast. In order to quantify the coating response, color image analysis was performed on samples after proper normalization to take into account the divergence in contrast caused by the substrate color. The nano-TiO₂ coating exhibits the highest intensity, followed closely by HA coating on the polymer composite substrate and finally HA coatings over Ti-6Al-4V substrate. These results indicate that even though no morphological difference was seen between the different substrates, the cell activity as defined by the alkaline phosphatase staining shows a difference. The reason for this difference is not explained at this point. However, it should be highlighted that the staining for ALP activity, as performed in this study, does not allow for a precise quantification. Also the large variation in the data especially for the HA coating over the Ti-6Al-4V substrate would justify further study. The quantification of ALP activity is very important especially for the rougher HA coating where only the stained surface is visible, whereas the cells embedded in the valleys or in the re-precipitated apatite are not shown.

The interpretation of the observed differences of the osteoblast initial adhesion and proliferation for the two coatings can be quite complex. Differences in coating chemistry may play a role. For titanium alloys, chemistry (i.e., pure Ti, Ti-6Al-4V, TiNb₁₃Zr₁₃, TiNb₃₀) may induce different responses. Also titanium oxide formed by laser heating might have a different effect than native oxide. Another important factor linked to the cell adhesion is the wettability of the surface, which can have either a direct effect on adhesion by promoting the cell contact with the surface or an indirect one by promoting the protein unfolding at the surface. The effect of protein type on cell adhesion is also a factor to be considered. For example, vitronectin, fibronectin or osteopontine have an effect on cell adhesion. Transmembranous integrins might play a role in the signal transduction from the environmental milieu up to the cell nucleus leading to an appropriate cell response such as proliferation rates or morphology. This signal seems to be the consequence of the interaction of various molecules and growth factors.

Regarding the effect of surface roughness, osteogenicity may be enhanced by increasing surface roughness. However, for samples with the highest roughness, cells were less adhesive, which may be attributed to an effect of confinement of cells at the bottom of deep holes, leading to early decease and detachment, possibly an observation related to in vitro experiments. This apparent negative effect of high surface roughness could be attributed in part to the fact that at the cell level the surface appears to be flat.

The tie layer used in the instant example clearly showed good bonding ability, and permitted the study of the development of osteoblast colonies on the bioactive coatings. Early stage of cell adhesion was characterized by direct observation of the coating surfaces. Both nano-TiO₂ and HA coatings applied using the tie layer support the attachment, growth, and expression of the osteoblastic phenotype of the cells as assessed by the ALP activity assay.

Results on cells adhesion and proliferation demonstrate that hydroxyapatite coatings on a polymer composite are at least as good as HA coatings deposited on a Ti-6Al-4V substrate, in terms of osteoblast cell activity. The tie layer achieved good bonding in order to allow this assessment.

Nano-TiO₂ coatings produced by the HVOF technique are behaving differently when compared to HA coatings. Preliminary osteoblast cell culture revealed that the activity of the cells after 15 days of incubation is at least equivalent to that observed on hydroxyapatite coatings.

### Example 4

### Bioactive HA Coating

To evaluate the feasibility of HA coatings of acceptable adhesion on a prosthetic bone, flat coupons of CF/PA12 composite were prepared and coated by plasma spraying.

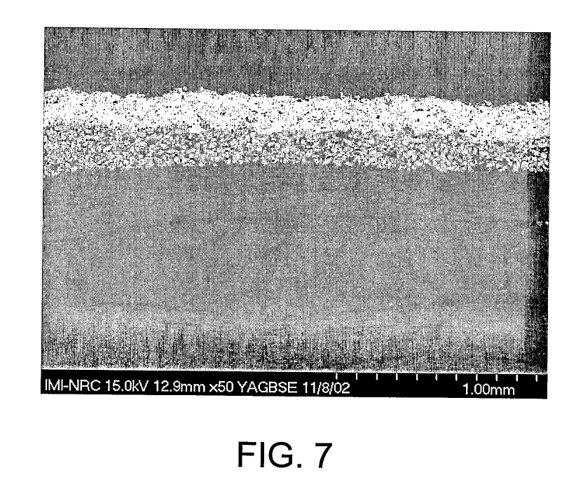

FIG. 7 illustrates an exemplary surface of HA coating on a CF/PA12 composite with a tie layer according to an embodiment of the invention. The tie layer, (or “film interlayer”) is composed of 25% vol. in HA particles (mean diameter of 30 μm) in a PA12 matrix. This layer was obtained by incorporating HA particles in a PA12 matrix using a twin screw extruder (TSE) and pelletizing the PA12/HA compound. Then a 200-300 μm-thick film was produced from the pellets of this compound using a cast film line extruder. A composition of 25% (v/v) HA/PA12 for the compound was used. The film was then overmolded on the CF/PA12 composite cylindrical structures by inflatable bladder molding in a closed mold placed into a heated press. The resulting part was then coated with HA using plasma spray.

Results showed that an HA-filled polymer film affixed to the substrate surface prior to thermal spraying led to excellent results. The HA coatings showed very good integrity and adherence values above 21 MPa based on pull tests (ASTM C633), which is considered a standard value for thermal spray coatings in an aircraft turbine engine.

Given the complex geometry of prosthetic bone and the physiological loads involved, the shear stresses at the surface of an implanted prosthetic bone (a total hip prosthesis (THP) stem, for example) can be estimated in the 2-6 MPa range. Shear testing of the HA-coated composite coupons (ASTM D3163) showed that the shear strength of the coatings varied between 14 and 27 MPa. Preliminary shear fatigue testing of the coated composite coupons (ASTM D3166) showed that at the maximum physiological shear stress of 6-7 Mpa, and no fatigue was observed after 5,000,000 cycles. Considering the difference between the shear stresses involved, the shear strength of the coatings and the shear fatigue life at maximum physiological shear stresses, it appears that HA coating adherence is sufficient, at least on the flat composite coated coupons, to withstand the physiological conditions of an implanted THP.

The bioactivity of these HA coatings was assessed. The results showed that the plasma-sprayed HA coatings are highly crystalline (>65%), with the hexagonal JCPDS Standard 9-342 for HA representing above 99% of the crystalline phase.

The above-described embodiments of the present invention are intended to be examples only. Alterations, modifications and variations may be effected to the particular embodiments by those of skill in the art without departing from the scope of the invention, which is defined solely by the claims appended hereto.

### REFERENCES

1. Ashari et al, Thermal Spray Coatings for Fiber Reinforced Polymer Composites. in 15th. International Thermal Spray Conference. 1998. Nice France.
2. Smith et al. Thermal Spray Coatings of Polymeric Composite Air Craft Components. in 7th. National Thermal Spray Conference. 1994. Boston, Mass.: ASM international.
3. Lugscheider et al. Mechanical Properties of Thermal Sprayed Coatings on CRFP. in National Thermal Spray Conference. 1993. Anaheim, Calif.: ASM international.
4. Freslon, Plasma spraying at controlled temperature. in 8 th NTSC, 1995. Houston, Tex., USA: ASM international.
5. Abu Bakar, et al., Materials Science and Engineering A, 2003. 345(1-2): p. 55-63.
6. Cheang et al., Materials Science and Engineering A, 2003. 345(1-2): p. 47-54.
7. Roop Kumar et al., Materials Letters, 2002. 55(3): p. 133-137.
8. Sun et al., J. Biomatr. Sci. Polymer Edn, 2002. 13(9): p. 977-990.
9. Reardon, PLASMA SPRAYED BONDING COAT FOR PLASTIC SUBSTRATES. in Second National Conference on Thermal Spray. Meeting. 1985. Long Beach, Calif., USA: ASM, Metals Park, Ohio, USA.
10. Alonso et al., Plasma Spray Coatings on Carbon-Epoxy Substrates. in ASM Heat Treatment and Surface Engineering. II. 1992. Amsterdam, Netherlands.

1. A tie layer for bonding a ceramic or metallic coating to a thermoplastic substrate, comprising from 2 to 70% filler particles in a thermoplastic matrix, the thermoplastic matrix being compatible with the thermoplastic substrate,
the filler particles being ceramic, metallic, or a combination or composite thereof,
the filler particles being exposed on a surface of the tie layer for mechanical interlocking with the coating, and
the filler particles being able to withstand and dissipate heat of thermal spraying to protect the substrate from the heat.

2. The tie layer of claim 1 wherein the thermoplastic matrix comprises PA, polyamide; PET, polyethylene terephthalate; PBT, polybutylene terephthalate; PSU, polysulfone; PES, polyethersulfone; PAS, polyarylsulfone; PPS, polyphenylene sulfide; PC, polycarbonate; PA, polyamide; PAI, polyamide-imide; TPI, thermoplastic polyimide; PAEK, polyaryletherketone; PEEK, polyetheretherketone; PAEN, polyarylethernitrile; PE, polyethylene; PP, polypropylene; PEK, polyetherketone, or a combination of these.

3. The tie layer of claim 1 wherein the thermoplastic matrix comprises polyamide 12 (PA12).

4. The tie layer of claim 1 wherein the filler particles are ceramic.

5. The tie layer of claim 1 wherein the filler particles comprise hydroxyapatite, a CaP ceramic, stainless steel, WC—Co, zirconia (ZrO₂), alumina (Al₂O₃), silica (SiO₂), titania (TiO₂), or a combination or composite of these.

6. The tie layer of claim 1 comprising from 10 to 40% filler particles.

7. The tie layer of claim 1 containing particles ranging in diameter from 1 nm to 100 μm.

8. The tie layer of claim 7 containing particles in the nano range having a diameter of from 1 nm to 100 nm.

9. The tie layer of claim 7 containing particles ranging in diameter from 100 nm to 100 μm.

10. The tie layer of claim 1 having a thickness of from 0.05 to 1 mm.

11. The tie layer of claim 1 in the form of a film.

12. A method of bonding a ceramic or metallic coating to a thermoplastic substrate comprising:
applying a tie layer to the substrate, the tie layer comprising a thermoplastic matrix compatible with the thermoplastic substrate, and from 2 to 70% filler particles embedded in the matrix, the filler particles being ceramic, metallic, or a combination or composite thereof,
the filler particles being exposed on a surface of the tie layer for mechanical interlocking with the coating, the filler particles being able to withstand and dissipate heat of thermal spraying to protect the substrate from the heat; and
bonding the ceramic or metallic coating to the tie layer using a coating process that consolidates the substrate, the tie layer and the coating.

13. The method of claim 12 wherein the coating process for bonding the ceramic or metallic coating to the tie layer comprises thermal spray material deposition.

14. The method of claim 12 wherein the coating process for bonding the ceramic or metallic coating to the tie layer comprises plasma spraying, arc-spraying, high velocity oxy-fuel spraying (HVOF), cold spraying, vacuum plasma spraying (VPS), kinetic metallization, or cold gas dynamic application.

15. The method of claim 12 wherein the tie layer is formed as a film prior to application to the substrate.

16. The method of claim 15 wherein the film is formed by extrusion stretched from melt or is blown from melt form using air.

17. (canceled)

18. (canceled)

19. (canceled)

20. The method of claim 12 wherein the tie layer is applied to the substrate by spraying, compression molding, injection overmolding, or co-injection molding.

21. The method of claim 12 wherein the tie layer has a thickness of from 0.05 to 1 mm.

22. The method of claim 12 additionally comprising the step of preparing the tie layer to expose particles on the surface of the tie layer.

23. The method of claim 22 wherein the step of preparing the tie layer surface comprises sand blasting, sanding, etching, polishing or scratching.

24. The method of claim 12 wherein from 10 to 40% filler particles are embedded in the matrix.

25. A method of bonding a ceramic or metallic coating to an implantable prosthetic bone comprising applying a tie layer according to claim 1 to a prosthetic bone and subsequently bonding the ceramic or metallic coating to the tie layer using thermal spray material deposition.
